(19) United States
(12) Patent Application Publication
(10) Pub. No.: US 2001/0045348 A1
(43) Pub. Date: Nov. 29, 2001

(54) Switch assembly

(76) Inventors: Stephen Horner, Fenton, MI (US); Jonathan R. Penvose, Clarkston, MI (US); Daniel J. Du Rocher, Leonard, MI (US); Bruce H. Van Vlack, Goodrich, MI (US); Ramanial Chauhan, Leicester (GB); Brian G. Nicholson, Redditch (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 09/778,526

(22) Filed: Feb. 7, 2001

Related U.S. Application Data
(60) Provisional application No. 60/180,978, filed on Feb. 8, 2000.

(51) Int. Cl. H01H 9/00

(52) U.S. Cl. 200/61.54

(57) ABSTRACT

A multi-function steering column switch assembly for a vehicle comprising a mounting body (15) for attachment to a stationary part (11, 12) of the vehicle steering column assembly in use, a plurality of manually operable switch mechanisms (16, 17) secured to the mounting body, a circuit board arrangement (19, 21, 22) carried by said mounting body, means electrically connecting the contacts of said switch mechanisms with respective conductors of the contact board arrangement, active electronic components carried by the circuit board arrangement for interpreting signals generated by operation of the contacts of said switch mechanism and for generating corresponding databus messages, and, connection means on said circuit board arrangement for connecting said active components to the vehicle databus in use.

This invention relates to a multi-function steering column switch assembly for a vehicle.

It is recognised that a multi-function steering column switch assembly may perform a large number of switching functions, and thus will require a correspondingly large number of electrical connections. Conventionally a relatively bulky wiring harness containing a large number of electrical leads must be routed from the switch assembly through the steering column housing and into the main wiring harness of the vehicle.

The advent of databus wiring systems for vehicles has enabled the bulk of the main wiring harness of the vehicle to be greatly reduced, but conventionally there is still a need for a relatively bulky harness section within the steering column to interface the multi-function switch assembly with the data processing circuitry of the vehicle electrical system. It is an object of the present invention to provide a multi-function column switch assembly which minimises this problem. It is a further object of the present invention to provide a switch assembly which can be constructed from modules which may be common to a plurality of different assemblies and whose function within the constructed switch assembly is determined by the vehicle electrical system in response to data provided by each module.

In accordance with the present invention there is provided a multi-function steering column switch assembly for a vehicle comprising a mounting body for attachment to a stationary part of the vehicle steering column assembly in use, a plurality of manually operable switch mechanisms secured to the mounting body, a circuit board arrangement carried by said mounting body, means electrically connecting the electrical contacts of said switch mechanisms with respective conductors of the contact board arrangement, active electronic components carried by the circuit board arrangement for interpreting signals generated by operation of the contacts of said switch mechanism and for generating corresponding databus messages, and, connection means on said circuit board arrangement for connecting said active components to the vehicle databus in use.

It will be recognised that providing the active electronic components on the circuit board for interpreting operation of the switch mechanisms and generating corresponding databus messages allows the electrical connecting leads which must be routed through the steering column assembly to be reduced to a minimum since the databus messages are generated at the multi-function switch assembly, rather than at a remote point in the vehicle electrical system.

One example of the present invention is illustrated in the accompanying drawings, wherein:

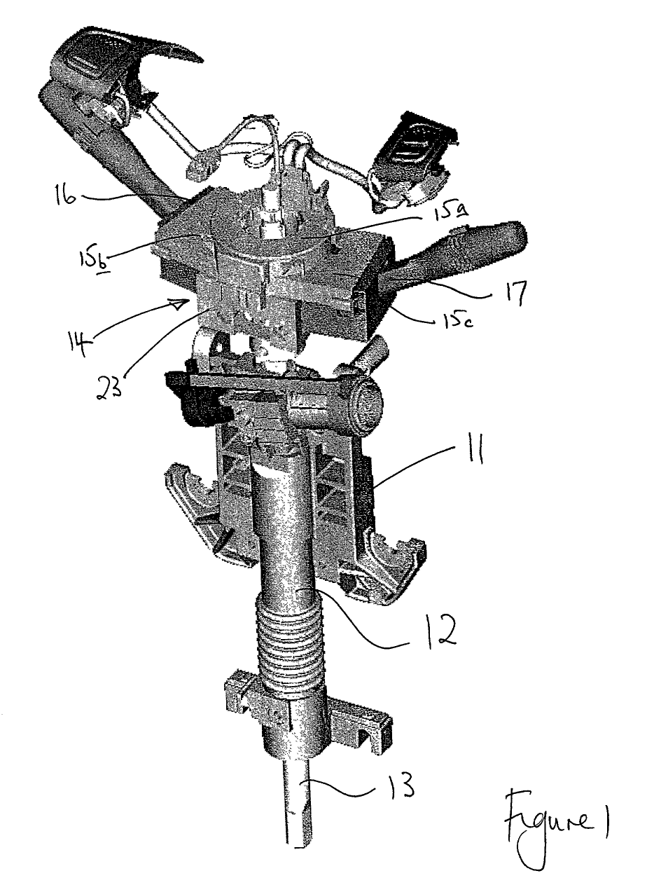

FIG. 1 is a diagrammatic, partially exploded, perspective view of a vehicle steering column assembly with the outer cover thereof removed,

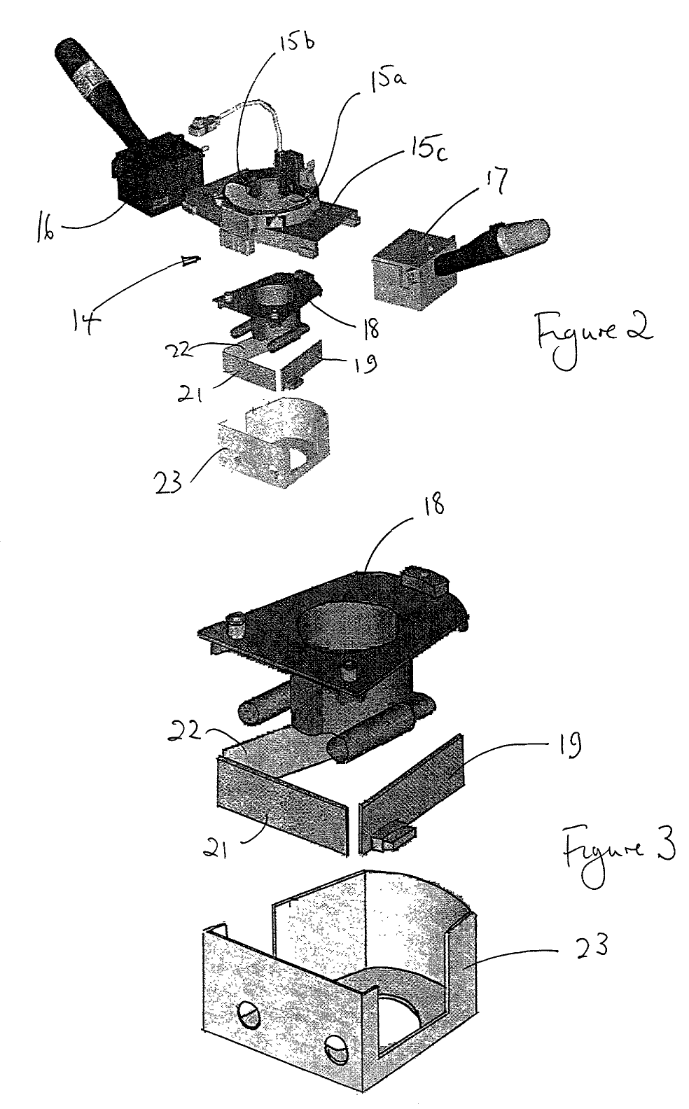

FIG. 2 is an exploded perspective view of the multi-function switch assembly of FIG. 1, and

FIG. 3 is an enlargement of part of FIG. 2.

Referring to the drawings, it can be seen that the vehicle steering column assembly includes a stationary support structure 11 to which the outer sleeve 12 of the steering column is secured. The steering shaft 13 extends through the sleeve 12, and at its upper end 13a extends through a centrally disposed aperture in a multi-function steering column switch assembly 14 to receive the steering wheel of the vehicle.

The multi-function switch assembly 14 includes a moulded synthetic resin mounting body 15 having a central, annular boss 15a through which the shaft 13 extends in use. On opposite sides of the boss 15a the body 15 includes outwardly directed mounting plates 15b, 15c to which first and second stalk operated multi-function switch mechanisms 16, 17 are secured conveniently by being snap-fitted into corresponding recesses in the body 15.

The switch mechanism 16, 17 are generally conventional and each includes an elongate stalk which can be moved relative to the respective switch body in a pair of mutually perpendicular planes, to operate different sets of contacts, and each stalk includes a rotary switch element. Conventionally, the switch 16 will be the turn signal switch and the switch 17 will be the windscreen wiper control switch. The turn signal switch may incorporate a lighting control switch operated by rotation of part of the stalk, and the switch 17 may include a wiper speed switch operated by rotation of part of its operating stalk.

The mounting body 15 includes an anchorage component 18 which is formed as a separate moulding, but is rigidly secured to the body 15 in use. The anchorage component provides the actual mounting to the stationary part of the steering column assembly and provides a mounting point for three printed circuit boards 19, 21, 22, which together define a circuit board arrangement of the multi-function switch assembly. The boards 19, 22 are disposed generally parallel to one another and perpendicular to the board 21 and in use the three boards are anchored to the component 18 so as to be disposed around the axis of the steering column. An outer protective housing 23 receives the boards 19-21 and the component 18 in use.

The mounting body 15 carries electrical connection components (not shown) including first terminals which engage terminals on the exterior of the switch mechanisms 16, 17 when the switch mechanisms are correctly secured to the mounting body 15. The connection components may be of plug and socket form in which the exterior terminals of the switch mechanisms mate with said first terminals on the body 15, or may be of facial contact form in which the switch mechanism exterior terminals abut said first terminals. The connection components include second terminals which are electrically connected to the circuit board arrangement 19-22 thus providing appropriate electrical connections between the board arrangement 19-22 and the contacts of the various switching functions of the switch mechanisms 16, 17.

The circuit board arrangement 19-22 carries a number of active electronic components which interpret the signals generated by opening and closing of various contact sets of the switch mechanisms 16, 17 and convert them into databus messages using a coding arrangement recognised by the main data processing circuitry of the vehicle electrical system. It is to be understood that integrated circuit techniques may permit this coding function to be provided by a single active component, and that therefore the number of actual circuit boards which go to make the circuit board arrangement may well be reduced. For example, in a modification the three boards 19, 21, 22 are replaced by a single, larger printed circuit board secured to the underside of the mounting body 15 parallel with the plane thereof, and having a centrally disposed aperture through which the steering shaft extends with clearance.

The design arrangement is such that each switching function has a unique electronic identifier whereby different switch units can be plugged into the central housing and be instantly recognised by the control electronics of the system. Such an arrangement provides the flexibility easily to produce a product to the customers specification with the ability to readily be adapted to suit different platforms.

In the preferred embodiment the mounting body 15 carrying the printed circuit boards 19, 21, 22 will be a common core unit in the sense that it is a unit which can be used in a wide variety of different switch assemblies, and thus can be stocked as a single component suitable for incorporation into a plurality of switch assemblies. The switch mechanisms 16, 17 will be modules which are specific to a basic function such as direction indicator switching or wiper switching of the vehicle but may well have additional features which are used in some switch assemblies but not in others. In other words the switch mechanisms may include functions which are redundant in some switch assemblies. It will be appreciated however that if desired specific switch mechanisms 16, 17 could be provided for each function and combination of functions necessary, and the use of a common core assembly 15, 19, 21, 22 still substantially reduces the number of components which must be stocked in order to produce a range of switch assemblies. In order that the vehicle electrical system recognises switch mechanisms or modules coupled to the body 15, and so produces the desired effect upon operation of one or more sets of contacts of the module, each module 16, 17 generates an identifier which is recognised by the system so that the system can load appropriate software for that module. The “identifier” may be passive or active depending on the overall architecture chosen for the vehicle electrical system. In the preferred embodiment the modules 16, 17 are part of an RMUX system (a resistive multiplex system) which uses various voltage levels to identify the operation of a specific module, or function within a module. For example the various switch functions of a module, or within a module, could be identified by shunting resistances on a “resistance ladder”, and the active components of the circuit boards 19-22 would recognise the voltage drop when that particular module is connected to the core unit 15 and would provide coded signals to the vehicle electrical system to ensure that the system loads the appropriate software for that module. In a simple case, the “identifier” could be the base resistance value of the switch module, that is to say the resistance of the module seen by the active components on the boards 19-22 when the switch module is connected to the boards 19-22 with all of its switching functions set to the “OFF” position.

If for example each possible variant of each module 16, 17 is assigned a different base resistance value then when that switch module is attached to the core unit 15 the active processing circuitry of the boards 19-22 would recognise that base resistance value and would then load the appropriate software for that module variant either in the circuitry of the boards 19-22, or by virtue of signals sent on the multiplex databus, within the central processing circuitry of the vehicle.

It will be understood that in an active version of the system each variant of each module could include some form of digital transponder so that each module variant actually generates its own digital identifier when the vehicle electrical system is powered-up and each function in the vehicle electrical system is interrogated by the central control system.

The ability to code the signals generated by the various switching functions of the multi-function switch assembly within the assembly itself, to produce the appropriate databus messages, permits the use of a minimal wiring harness extension routed within the steering column assembly. In its simplest form a single wire could be utilised to carry the coded databus messages from the switch assembly circuit board arrangement to the main databus of the vehicle. Messages generated within the multi-function switch assembly 14 are interpreted by the control system of the vehicle and are utilised to control the functioning of the respective equipment of the vehicle.

It will be recognised that other switch mechanisms could if desired be associated with the same circuit boards, and could be connected thereto by flying leads if desired.

What we claim is:

1. A multi-function steering column switch assembly for a vehicle comprising
a mounting body for attachment to a stationary part of the vehicle steering column assembly in use,
a plurality of manually operable switch mechanisms secured to the mounting body,
a circuit board arrangement carried by said mounting body,
means electrically connecting the electrical contacts of said switch mechanisms with respective conductors of the contact board arrangement,
active electronic components carried by the circuit board arrangement for interpreting signals generated by operation of the contacts of said switch mechanism and for generating corresponding databus messages, and,
connection means on said circuit board arrangement for connecting said active components to the vehicle databus in use.

2. A multi-function steering column switch assembly as claimed in claim 1 wherein assembly of a switch mechanism to the mounting body permits the application of a unique identifier to said active electronic components carried by the circuit board arrangement, to identify the switch mechanism to the vehicle electrical system in use.
